(19) United States
(12) Patent Application Publication
(10) Pub. No.: US 2015/0322286 A1
(43) Pub. Date: Nov. 12, 2015

(54) Polymerized Metal-Organic Material for Printable Photonic Devices

(71) Applicant: THE REGENTS OF THE UNIVERSITY OF CALIFORNIA, Oakland, CA (US)

(72) Inventors: Stefano Cabrini, Albany, CA (US); Christophe Peroz, San Francisco, CA (US); Carlos Alberto Pina-Hernandez, Berkeley, CA (US)

(73) Assignee: The Regents of the University of California, Oakland, CA (US)

(21) Appl. No.: 14/443,347

(22) PCT Filed: Nov. 26, 2013
(86) PCT No.: PCT/US13/72109

§ 371 Date: May 15, 2015

Related U.S. Application Data
(60) Provisional application No. 61/730,354, filed on Nov. 27, 2012.

(51) Int. Cl. C09D 163/00; B05D 1/18; C09D 135/08; C09D 133/10; C09D 133/08; B05D 1/00; B05D 1/02

(52) U.S. Cl. CPC C09D 163/00; B05D 1/005; B05D 1/18; B05D 1/02; C09D 133/10; C09D 133/08; C09D 135/08

(57) ABSTRACT

To manufacture a nanophotonic device, a metal oxide precursor is mixed with an organic acid, an organic polymer and a photoinitiator in a solvent to form a dispersion comprising a hybrid organic-inorganic phase. A film is formed on a substrate form the dispersion, the film including the hybrid organic-inorganic phase. The film is annealed to transform the hybrid organic-inorganic phase into an inorganic phase.

### RELATED APPLICATIONS

This application claims priority to PCT Application PCT/US2013/072109, filed Nov. 26, 2013, which in turn claims priority to U.S. Provisional Patent Application No. 61/730,354, filed Nov. 27, 2012, which is herein incorporated by reference.

### STATEMENT OF GOVERNMENTAL SUPPORT

This invention was made with government support under Contract No. DE-AC02-05CH11231 awarded by the U.S. Department of Energy, and was sponsored by the Air Force Office of Scientific Research (AFOSR), Air Force Material Command, USAF, under grant/contract number FA9550-12-C-0055. The government has certain rights in this invention.

### BACKGROUND OF THE INVENTION

1. Field of the Invention

The present invention relates to the field of nanoimprint lithography (NIL).

2. Related Art

The nanopatterning of high refractive index optical films promises the development of novel photonic nanodevices such as planar waveguide circuits, nano-lasers, micro and nano-lenses, light splitters, photonic crystals, solar cells and antireflective coatings. One of the most attractive materials is titanium oxide (TiO₂) with its high refractive index and its high transmittance in visible wavelength range. Several approaches have been investigated to create TiO₂ nanophotonic structures by photolithography, electron beam lithography, plasma etching, ion beam lithography, two photon lithography and direct-write assembly. However, these methods are limited by low throughput, expensive multiple processing steps, and difficulties in the etching of TiO₂, and may be limited to small areas.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 illustrates a direct imprinting process for inorganic films, in accordance with one embodiment.

FIG. 2 illustrates one embodiment for a method of direct imprinting an inorganic film.

FIG. 3 illustrates a reverse imprinting process for inorganic films, in accordance with one embodiment.

FIG. 4 illustrates one embodiment for a method of reverse imprinting an inorganic film.

FIG. 5A illustrates refractive indexes of example TiO₂ films for various annealing temperatures, in accordance with embodiments.

FIG. 5B illustrates extinction coefficients of example TiO₂ films for various annealing temperatures as a function of the wavelength for an annealing time, in accordance with embodiments.

FIG. 6A illustrates transmittance of example TiO₂ thin films annealed at 500° C. for different anneal times, in accordance with embodiments.

FIG. 6B illustrates transmittance of example TiO₂ thin films annealed at different temperatures for one hour, in accordance with embodiments.

FIG. 7 illustrates SEM pictures of example imprinted TiO₂ films showing shrinkage induced by the annealing process, in accordance with embodiments.

FIG. 8 illustrates SEM micrographs of 40 nm pitch patterns (14 nm linewidth) transferred into silicon by using RIE and the TiO₂ resin as an etching mask, in accordance with embodiments.

FIG. 9A illustrates optical characterization of an imprinted photonic chip manufactured in accordance with one embodiment.

FIG. 9B illustrates output signal intensity vs. propagation length and the corresponding exponential decay fit for an imprinted photonic chip manufactured in accordance with one embodiment.

FIG. 10 illustrates a cross sectional side view of a portion of a printed demultiplexer-on-chip based on a digital planar hologram (DPH).

### DETAILED DESCRIPTION

In the discussions that follow, various process steps may or may not be described using certain types of manufacturing equipment, along with certain process parameters. It is to be appreciated that other types of equipment can be used, with different process parameters employed, and that some of the steps may be performed in other manufacturing equipment without departing from the scope of this invention. Furthermore, different process parameters or manufacturing equipment could be substituted for those described herein without departing from the scope of the invention.

In one embodiment, a patterned metal oxide structure is manufactured by mixing a metal oxide precursor (e.g., a TiO₂ precursor) with an organic acid, an organic polymer and a photoinitiator in a solvent to form a dispersion comprising a hybrid organic-inorganic phase. A film is formed on a substrate from the dispersion, the film including the hybrid organic-inorganic phase. The film may be an imprinted film that is imprinted by one of a direct imprinting process, a reverse imprinting process or an indirect imprinting process. The film is annealed to transform the hybrid organic-inorganic phase into an inorganic phase by removing organic material from the organic-inorganic phase. The resultant patterned film having the inorganic phase (e.g., resultant TiO₂ film) may have an index of refraction of 1.7-2.2 in one embodiment.

Various embodiments of the invention describe robust routes for high throughput, high performance nanophotonics based direct imprint of high refractive index, low visible wavelength absorption materials. Other embodiments describe high throughput, high performance nanophotonics based reverse imprinting of high refractive index, low visible wavelength absorption materials. A titanium-based inorganic-organic hybrid material described in embodiments may be used for imprinting TiO₂ crack-free films over a large area. The process allows the patterning of TiO₂ films with features sizes down to 5 nm in one embodiment. The optical properties of the imprinted photonic films can easily be tuned with a simple post-annealing step and are suitable for fabricating printable photonic devices. Photonic devices such as a ridge waveguide, a micro or nano-lens array, a 1-dimensional, 2-dimensional or 3-dimensional photonic crystal, an integrated optical circuit, and a planar hologram may be formed in embodiments.

Various embodiments describe a novel strategy to pattern optical functional films with high refractive index over large areas. The approach is used to demonstrate the patterning of sub-10 nm features into inorganic films by nanoimprint lithography. The optical properties of the nanostructured films are easily tuned by post-annealing and their optical transparency is suitable with photonic applications. These results open a promising route for fabricating printable photonic nanodevices with high resolution and high-throughput.

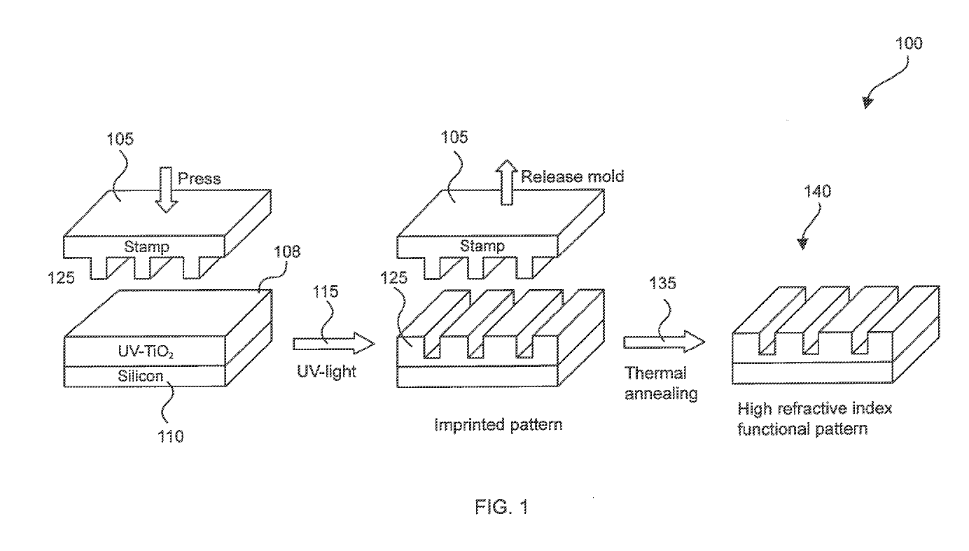

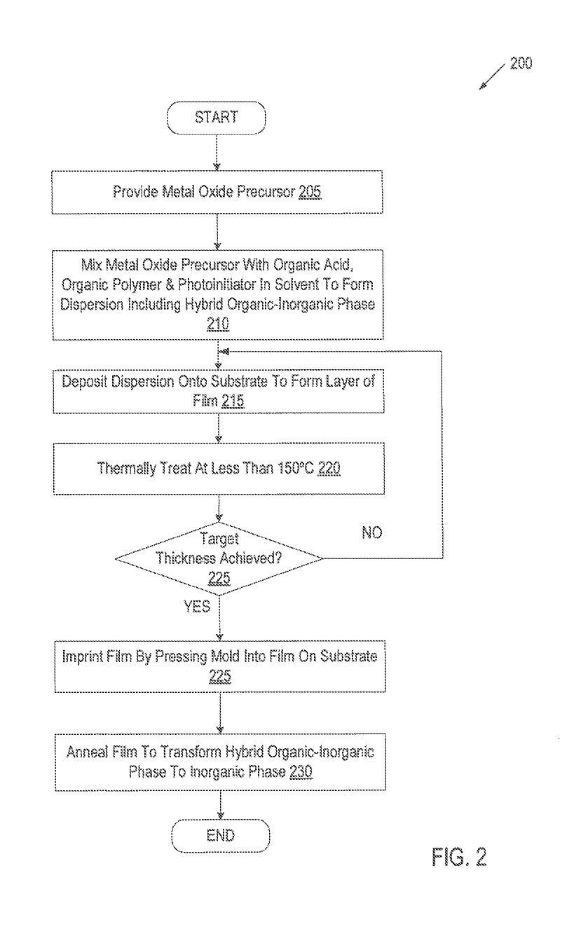

FIG. 1 illustrates a direct imprinting process for inorganic films, in accordance with one embodiment. A film 108 having a hybrid organic-inorganic phase (referred to as an organometallic material) is formed on a substrate 110. In the illustrated embodiment, the film is a material including a metal oxide, an organic acid, an organic polymer and a photoinitiator in a solvent. One example of such a film 108 is a UV-TiO₂ resin. The material is discussed in greater detail below with reference to FIG. 2.

A stamp or template 105 is pressed into the film 108. The stamp or template may be manufactured from a master mold, which may be a hydrogen silsesquioxane (HSQ) mold, a silicon master mold, a quartz master mold, soft polymer mold like polydimethylsiloxane or other soft or hard master molds.

Templates or molds 105 may then be replicated from the master mold. The mold 105 may be a rigid mold or a flexible mold. Some examples of flexible molds include ormostamp templates, polyethylene terephthalate (PET) templates, polyurethane molds, hard-polydimethylsiloxane (PDMS) bilayer templates, and polyvinyl alcohol molds. Some examples of rigid molds include HSQ molds, silicon molds, SiO₂ molds, Si₃N₄ molds, and SiC molds. The master molds may include patterned surface features to be transferred to a mold or template, and ultimately to a substrate of a photonic device. Examples of patterned surface features include gratings, ridges, pillars, bumps, dots, holes, columns, trenches, mesas, and so forth. The molds may have feature sizes on the microscale and/or nanoscale. Feature sizes in the molds may be selected so as to take into account a predicted lateral shrinkage and/or vertical shrinkage of imprinted films.

The mold 105 is pressed into the film 108 on the substrate 110. The film 108 is then exposed to ultraviolet radiation (light) 115 in one embodiment to cure the film. Alternatively, the film may be thermally cured. The film may be exposed to the UV light or heat to cure the film while the mold is pressed into the film. The film 108 may be imprinted at low pressure (e.g., <1.5 bar) and cured under 100 W/cm² UV light exposure for 3 minutes in one embodiment. Other pressures, cure times and UV-light doses may also be used. The cure time may vary from 30 seconds to 10 minutes in one embodiment. The UV-light dose may vary from 50-100 W/cm² in one embodiment. The pressure may vary from 1.1-20 bars in one embodiment. In one embodiment, a pressure of 1.5-4.5 bars is used.

The mold 105 may be released from the film, leaving behind an imprinted pattern 125 in the film. The imprinted pattern 125 may be annealed via a thermal anneal or a photo anneal process. In one embodiment, thermal annealing is performed (e.g., on a hot plate in air) at temperatures of up to 500° C. An anneal temperature and anneal time may be adjusted to control the optical properties, i.e. optical transmission T, refractive index n and extinction coefficient k, of the imprinted pattern.

FIG. 2 illustrates one embodiment for a method 200 of direct imprinting an inorganic film. At block 205 of method 200, a metal oxide precursor is provided. The metal oxide precursor may be any metal oxide based on group III to group XII metals and/or group XIII to group XVI metalloids. In one embodiment, the metal oxide precursor is one of a metal alkoxide or a metal halide. One example of a metal oxide precursor that may be used is a titanium oxide precursor such as titanium ethoxide (Ti₄(OCH₂CH₃)₁₆).

At block 210, the metal precursor is mixed with an organic acid, an organic polymer and a photoinitiator in a solvent to form a dispersion including a hybrid organic-inorganic phase. The order in which the metal precursor, organic acid, organic polymer, photoinitiator and solvent are combined may vary. In one example, the metal precursor may first be mixed with the organic acid, after which the organic polymer, then the photoinitiator, and finally the solvent may be added. However, the components may alternatively be mixed in any other order. The metal precursor, organic acid and organic polymer may be mixed in stoichiometric ratio.

The organic acid may be a functionalized or a non-functionalized acid. Examples of functionalized acids that may be used include 3-butenoic acid, acetic acid, acrylic acid, methacrylic acid, and epoxy-functionalized acid. If a functionalized organic acid is used, the metal oxide precursor may react with the functionalized organic acid to form a functional ester. Examples of non-functionalized acids that may be used include acetic acid, propanoic acid, or butenoic acid. In the example of 3-butenoic acid mixed with titanium ethoxide, the functional ester that is formed is titanium tetra-3-butenoate. Other functional esters will be formed with different combinations of functionalized acids and metal oxide precursors. If a non-functionalized organic acid is used, the acid may stabilize the metal oxide precursor in a solution.

The organic polymer may be an olefinic polymer that will function as a crosslinker. In one embodiment, the organic polymer functions as a photoreactive crosslinker. Alternatively, the organic polymer may function as a thermal-reactive crosslinker. The organic polymer mechanically strengthens and hardens the film upon curing, and mitigates the formation of cracks. The organic polymer may or may not be functionalized. Examples of organic polymers that may be used include methacrylate, acrylate, an epoxide, or a vinyl ether.

The photoinitiator may be any photoinitiator that achieves photocuring by means of free radical or cationic polymerization. Examples of photoinitiators that may be used include acetophenone based photoinitiators (e.g., 2-Hydroxy-2-methylpropiophenone), benzophenone based photoinitiators, cationic photoinitiators, and so on. Combinations of different photoinitiators may also be used.

The solvent may be a non-polar organic solvent such as toluene, or hexane. Other organic solvents may also be used. Alternatively, the solvent may be a polar aprotic solvent such as dimethylformamide (DMF). In one embodiment, the solvent is propylene glycol methyl ether acetate (PGMEA). Additionally, combinations of solvents may be used. The dispersion including the mixture of the metal oxide, the organic acid, the organic polymer, the photoinitiator, and the solvent may include from 0.1% to 99% solvent. In one embodiment, the mixture contains 5-95% solvent. The ratio of the solvent that is used in the dispersion may be adjusted to control a thickness of a film that is ultimately formed from the dispersion. Increasing the amount of solvent that is used causes the thickness of deposited films to be reduced, whereas reducing the amount of solvent in the dispersion causes the film thickness to increase. Additionally, the ratio of the metal oxide precursor that is used may be adjusted to modify the thickness. Increasing the ratio of the metal oxide precursor may generate thicker films.

In one embodiment, a hybrid UV-TiO₂-based resin is synthesized by mixing a titanium ethoxide precursor with 3-butenoic acid, a photoinitiator and an organic crosslinker dissolved in a propylene glycol methyl ether acetate (PGMEA) solvent. In one embodiment, the UV-TiO₂-based resin is prepared by mixing 0.684 g of titanium ethoxide with 1.032 g of 3-butenoic acid to form titanium-3-butenoate. In one embodiment, the titanium-3-butenoate is formulated with 1.056 g of pentaerythritol tetracrylate which acts as a crosslinker. Then, 0.2 g of 2-hydroxy-2-methylpropiophenone may be added as a photoinitiator. Finally, this mixture may be dissolved in an amount of propylene glycol methyl ether acetate (PGMEA) to achieve a desired film thickness through a spin coating or other deposition process. In other embodiments, other constituent materials and/or amounts or ratios may be used. Additionally, the order in which the constituents are combined may be modified.

At block 215, the dispersion is deposited onto a substrate to form a thin film (or a first layer of a thin film). The substrate may be a planar substrate or a non-planar substrate, and may or may not have surface features. The dispersion may be deposited onto the substrate by performing a spin coating, dip coating, drop casting, spray coating, or doctor blade technique. Other coating techniques may also be used.

At block 220, the layer of the thin film is thermally treated for a time period to remove the solvent from the film. The time period may vary from 20 seconds to about 10 minutes. In one embodiment, the thin film is thermally treated at a temperature of less than 200° C. In one embodiment, the thin film is thermally treated at 100° C. for 1 min to create uniform solvent-free films. Alternatively, the film may not be thermally treated, and the solvent may be allowed to evaporate at room temperature.

At block 225, a determination is made as to whether a target thickness has been achieved. This may take into account predicted shrinkage of the film during a later annealing operation. The shrinkage may vary from 40-60% in thickness in embodiments. Accordingly, if a final thickness of 0.5 microns is desired, than a target thickness of 1.0 microns may be used. In some embodiments, film shrinkage is up to 90%. Accordingly, if a final thickness of 0.5 microns is desired, then a target thickness of 5 microns may be used. In one embodiment, each layer may have a film thickness from 20 nm up to 1 μm after anneal depending on the concentration of the metal oxide precursor and the concentration of the solvent. In one embodiment, each layer of the thin film has a deposited thickness of approximately 500 nm to 5 microns, which may ultimately shrink to a thickness of anywhere from 50 nm to 2.5 microns depending on the dimensionality of the film (e.g., the dimensionality of patterns in the film) and the shrinkage.

If a target thickness has been achieved, then the method continues to block 225. If the target thickness has not been achieved, then the method returns to block 215, and the dispersion is again deposited onto the substrate to form an additional layer over the previous layer.

At block 225, the deposited film is imprinted by pressing a mold into the film on the substrate. The mold may be pressed into the film with a pressure that is 1.5 bar or higher in one embodiment (e.g., up to 10 bar). In one embodiment, a pressure of 5-100 pounds per square inch (psi) is used. In a further embodiment, a pressure of 10-60 psi is used. In one embodiment, the film is exposed to UV light while the mold is pressed against the substrate to cure the film. The UV light may cause the photoinitiator to decompose into free radicals, and may further cause the organic polymer to cross-link the hybrid organic-inorganic phase in the film. The UV light may have a power of 50-200 W/cm³, and may be applied for a duration of 30 seconds to 10 minutes in one embodiment. In one particular embodiment, a power of 100 W/cm² and a duration of 3 minutes are used. In an alternative embodiment, the film is thermally cured. A temperature of 100-300° C. may be used to thermally cure the film in one embodiment. In one embodiment, a temperature of 250° C. is used to perform the curing.

At block 230, the mold is removed from the film, and the film is then annealed to transform the hybrid organic-inorganic phase into an inorganic phase. In one embodiment, an annealing temperature of 200-800° C. is used, and an annealing time of 1 minute to 9 hours is used. In one particular embodiment, an annealing temperature of 350-500° C. and an annealing time of 30 minutes to 2 hours is used.

The resultant film may be an inorganic film with a high refractive index and high optical transmission (e.g., up to 90% or higher) in the visible and infrared spectrum. The resultant inorganic film may be crack free, and may have an index of refraction up to about 2.2 and an optical transmission of over 90% in the visible and infrared spectrum. A final thickness of the film may be anywhere from 10 nm to tens of microns. In one embodiment, the final film is a TiO2-based resin.

In one embodiment, a TiO₂-based film has a refractive index of 1.8 and a thickness of up to 1 μm. In another embodiment, the TiO₂-based film has a refractive index of 2.1 and a thickness of up to 500 nm. In both embodiments, the TiO₂-based film is cured via a UV-curing process. In one embodiment, in which a thermal curing process is performed, a TiO₂-based film has a refractive index of 1.8 and a thickness of up to 400 nm.

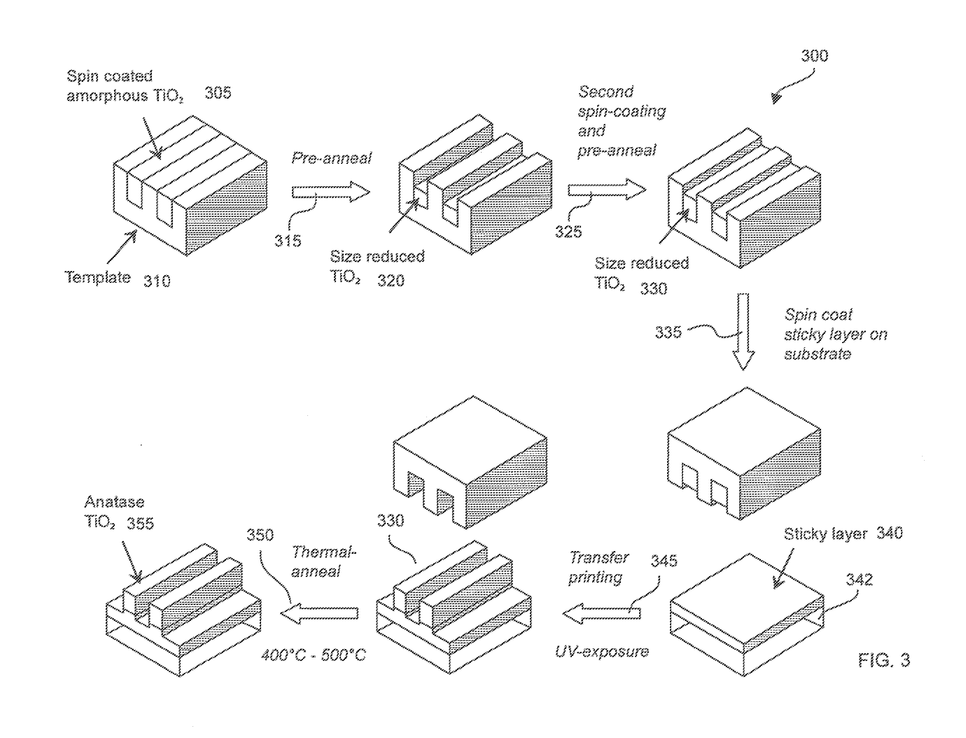

FIG. 3 illustrates a reverse imprinting process 300 for inorganic films, in accordance with one embodiment. A first layer of a film 305 is deposited (e.g., spin coated) onto a template or mold 310. The first layer may be any of the aforementioned films. The first layer may be applied via spin coating, dip coating, or other deposition techniques. In one embodiment, a TiO₂-based resist material is spin coated on top a PDMS or OrmoStamp mold.

A pre-anneal operation 315 is then performed by heating the first layer of the film. This pre-anneal operation may remove solvent from the layer of film and may further achieve pre-condensation of the material. The pre-condensation causes the film to shrink 320. In one embodiment, the film is heated at a temperature between 100° C. and 300° C. for 5-20 minutes. In one embodiment, the film is heated for 10 minutes.

A second layer of the film is subsequently deposited onto the template 310 over the first layer, followed by another pre-anneal operation. A resultant film 330 is shown.

An adhesive (sticky) layer 340 is deposited onto a substrate 342. Alternatively, the adhesive layer may be deposited onto the mold 310 over the film. In one embodiment, the adhesive layer 340 is an adhesive polymeric layer such as UV-TiO₂resist, OrmoStamp, or ormocomp. Other adhesive materials may also be used. Then, the mold 310 is placed on the substrate. The adhesive layer enhances adhesion between the TiO₂resist and the substrate.

Finally, UV-light or heat is applied to cure the film. The mold is subsequently detached, transferring 345 the film 330 to the substrate with a printed pattern. A thermal or photo anneal process may then be performed to tune the optical properties of the film. In one embodiment, a thermal anneal process at a temperature of 250-500° C. is performed.

Thus, the fabrication of multi-level patterned films can be achieved. Advantages over direct imprinting may include decrease in the shrinkage, multi-level structures, 3-D structures, and a zero residual layer.

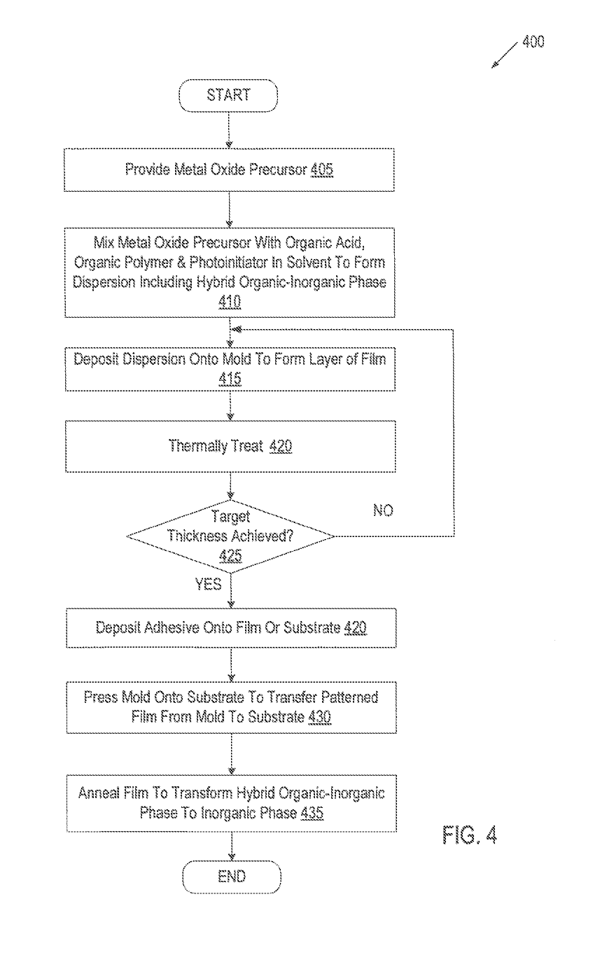

FIG. 4 illustrates one embodiment for a method 400 of reverse imprinting an inorganic film. At block 405, a metal oxide precursor is provided. At block 410, the metal oxide precursor is mixed with an organic (olefinic) acid to form a hybrid organic-inorganic phase. The hybrid organic-inorganic phase is further mixed with an organic polymer (crosslinker), a photoinitiator and a solvent to form a dispersion. The metal oxide precursor, organic acid, organic polymer, photoinitiator and solvent may be any of those previously described with reference to FIG. 2. Additionally, the previously described ratios of these materials may be used.

At block 415, the dispersion is deposited onto a mold to form a layer of film. The dispersion may be deposited by performing spin coating, dip coating, drop casting, spray coating, and so on. The layer of film may have a thickness of up to 1.5 microns. In one embodiment, the layer of film has a thickness of up to 0.6 microns. At block 420, the layer of film is thermally treated. In one embodiment, the layer of film is thermally treated at a temperature of 100-300° C. The thermal treatment may cause the thickness of the layer to be reduced by up to 40-80% and may evaporate the solvent.

At block 425, a determination is made as to whether the film has a target thickness. The film may have a target thickness, for example, when features within the mold are filled by the film. If the film has a target thickness, then the method continues to block 420. If the film does not have the target thickness, then the method returns to block 415, and an additional layer of the film is deposited onto the mold. Two or more layers of film may be deposited and then thermally treated. The thickness of each layer after thermal treatment may be up to 0.6 microns without introducing cracking in one embodiment. In an example, a target thickness is 1.2 microns. Accordingly, four layers of 300 nm each may be deposited to reach a film thickness of 1.2 microns.

At block 420, an adhesive film is deposited onto the substrate or onto the mold over the film. The adhesive layer will help to bond the film to the substrate. At block 430, the mold is pressed into the substrate. The film may be treated with UV light or heat to cure the film while the mold is in place. The film may cure and bond to the substrate, thus transferring the film from the mold to the substrate. At block 435, the film is then thermally or photo-annealed annealed to transform the hybrid organic-inorganic phase into an inorganic phase. In one embodiment, the film is heated at 200°-800° C. for anywhere from 1 minute to 9 hours. In one particular embodiment, the film is annealed at up to 500° C. for 1-4 hours.

In one embodiment, a metal oxide precursor is mixed with an organic acid to form a hybrid organic-inorganic phase. The hybrid organic-inorganic phase is mixed with an organic polymer and a photoinitiator. The mixture is added to a solvent (or a solvent is added to the mixture) to form a dispersion. The dispersion is deposited onto a substrate to form a film and annealed via a thermal or UV anneal process. After the anneal process, the film is a metal oxide-based film (e.g., a TiO₂-based film). A layer of patternable resist is then coated over the film. The layer of patternable resist is then patterned via standard lithography. Several lithography approaches can be used, such as photolithography, e-beam lithography, imprint lithography, laser interference lithography and scanning probe lithography. After the patterning operation is performed, etching techniques are employed to transfer the pattern into the film. The resist may then be removed.

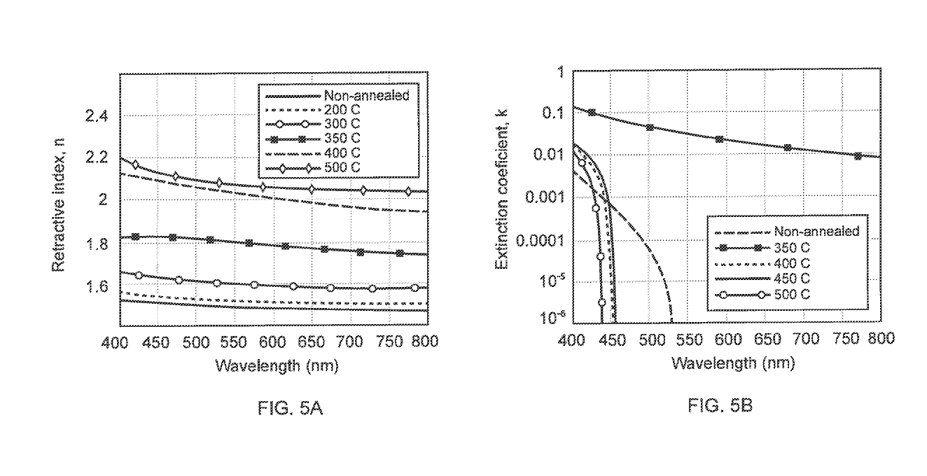

Nanostructures with a high refractive index and high transparency in the visible wavelength range are a component for the development of printable photonic devices. FIGS. 5A-5B illustrate ellipsometry characterization of some example TiO₂-based films for various annealing temperatures, in accordance with embodiments. The TiO₂-based films were formed using a dispersion of an organic-inorganic phase formed from a titanium ethoxide precursor and an organic acid, the dispersion further including an organic polymer, a solvent, and a photoinitiator. After deposition and patterning of the dispersion including the hybrid organic-inorganic phase, the film was annealed at various temperatures to convert the hybrid organic-inorganic phase into an inorganic phase of primarily TiO₂.

FIG. 5A illustrates refractive indexes n of TiO₂ films at various annealing temperatures at an annealing time of one hour. FIG. 5B illustrates extinction coefficients k of TiO₂ films as a function of the wavelength for an annealing time of one hour. The refractive index may be easily tuned and increased with annealing temperature. The refractive index is found to vary from n=1.60 up to 2.04 at a wavelength k=600 nm for some films, when the films are annealed from 200° C. up to 500° C.

The transparency of the inorganic films is an important condition to make photonic devices for visible light. FIG. 5B shows that the extinction coefficient k goes down to zero (below the detection level) for annealing temperatures higher than around 300° C. for some TiO₂-based films. The illustrated improvements in n and k arise due to the degradation of the organic component of the film (resist) having the hybrid organic-inorganic phase during the annealing process leading to a pure TiO₂ film. As more of the organic material is removed and the film densifies, the refractive index and the transparency of the films increases. Note that these refractive index and extinction coefficient values for specified anneal temperatures are for specific TiO₂ films formed in accordance with embodiments. Other refractive indexes and extinction coefficients may be achieved at different anneal temperatures for other films having the same or other metal oxide constituents.

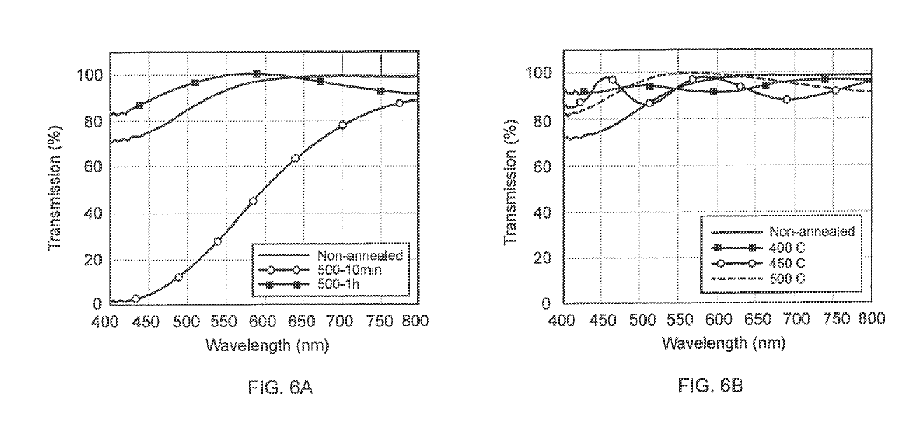

FIGS. 6A-6B illustrate transmittance of TiO₂-based thin films measured by UV-Vis spectrometer, the TiO₂ films having been formed in accordance with embodiments described herein above. FIG. 6A shows samples annealed at 500° C. for different times. FIG. 6B shoes samples annealed at different temperatures for one hour. The transmission of the coated films depends on the annealing time. For instance, a non-annealed film presents high transmission as observed in FIG. 6A. When such film is annealed at 500° C. for 10 min, the transmission decreases to less than 50% in one embodiment because the organic component of the resist is in the initial phase of thermal decomposition. However, a longer annealing time (e.g., 1 hour) produces a film with higher transparency (transmittance larger than 90% at 600 nm). This change in transparency is attributed to changes in the organic content. Before annealing, films may be tinted (e.g., with a yellow color in some embodiment). The color may darken for short annealing times. With a longer annealing time, organic components are removed and the sample becomes transparent. This time dependent behavior is typical as long as the films are annealed at high temperatures.

As shown in FIG. 6B, with longer annealing times and temperatures above 350° C., films are found to be suitably transparent. The post-annealing treatment may involve a change of the structural phase of the films. X-ray diffraction analysis demonstrates that the films may be amorphous after an annealing at 400° C. and become anatase polycrystalline for annealing at 500° C. and then rutile polycrystalline for annealing at 700 C.

Photonic integrated circuits provide unique functionalities for information signals and promise the emergence of a novel class of systems. Some potential applications for photonic integrated devices formed in accordance with embodiments include ultra-miniaturizes sensors, optical communications devices, data storage devices, quantum computing devices, and so on. Embodiments provide a monolithic integration process that enables consolidation of many devices with different functionalities into a single chip made of the same photonic material. Optical devices manufactured in accordance with embodiments herein may be directly replicated into TiO₂-based resist films by ultra-violet assisted nanoimprint lithography (UV-NIL). A rigid or flexible mold, that contains the design of the photonic devices is pressed into at the hybrid organic-inorganic resist (e.g., hybrid organic-inorganic TiO₂-based resist), and the functional resist is cross-linked (e.g., under UV light exposure). After demolding, a negative replica of the device is obtained into a resultant amorphous TiO₂ resist film. This process is suitable for sub-10 nm resolution patterning. Photonic integrated devices can be manufactured in just one or a few operations, and without any resist processing or plasma etch operations.

Some examples of imprinted nanostructures that may be formed include a ridge waveguide, a microlens array, a 1-dimensional photonic crystal and a planar hologram. An example grating may have an 8 nm line width and 16 nm pitch before post imprint annealing. Another example grating may have a 700 nm pitch imprinted onto TiO₂ films over 1 in².

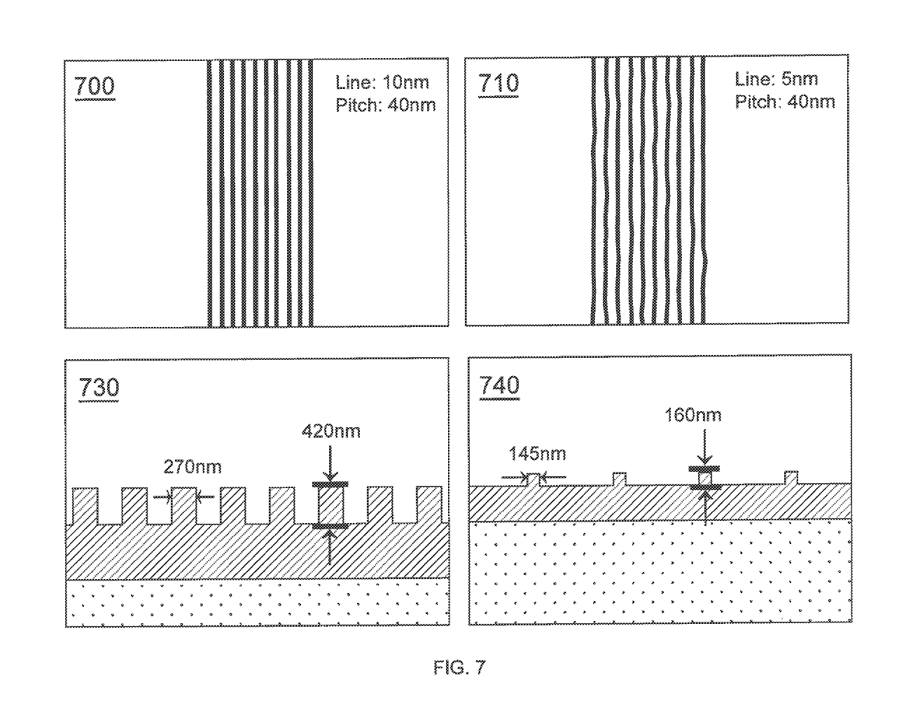

FIG. 7 illustrates SEM pictures of example imprinted TiO₂ films showing shrinkage induced by the annealing process, in accordance with embodiments. SEM picture 700 shows a top view of an imprinted grating. SEM picture 710 shows the grating after annealing at 400° C. for 10 min. SEM picture 730 is a cross section of an imprinted film showing a 270 nm line width and 700 nm imprinted pitch gratings. SEM picture 740 is a cross section of an imprinted film after the annealing process at 400° C. for 10 min. In one embodiment, the height of the pattern is decreased from 420 nm down to 160 nm after annealing. Note that the shrinkage for SEM picture 740 may not correspond to the shrinkage for SEM picture 730, because during the shrinkage the pitch may be kept constant.

FIG. 7 depicts some examples of patterns imprinted directly onto functional titania films. Gratings with sub-10 nm features and 16 nm pitch may be replicated into deposited inorganic films, in accordance with embodiments. Extremely small patterning resolution of films are achievable. The process described in embodiments allows patterning large areas with high homogeneity, which is useful for low-cost printable photonics. The size of the imprinted area may be based on the mold pattern area. In one embodiment, the patterned films remain crack-free after thermal annealing for films with initial film thickness of about 5 μm or less. The thickness uniformity is excellent with only a variation of a few nanometers, along an example 4 inch wafer for a 200 nm thick film. Atomic Force Microscopy (AFM) reveals also that the films are very smooth with a RMS value for roughness around 0.5 nm at an anneal temperature of 400° C.

The post-annealing of the films is associated to a shrinkage of the films due to the loss of organic matter of the NIL resist during the conversion of the hybrid organic-inorganic phase into the inorganic phase. In one embodiment, for a film annealed at 400° C. for one hour, the 1-Dimensional shrinkage is around 80% and goes up to 90% after annealing at 500° C. The films can also be annealed to get high refractive index by using UV light to burn the organic component of the hybrid organic-inorganic phase. In other embodiments, shrinkage of 40-80% may be achieved as desired. The shrinkage for the imprinted nanostructures may be investigated by measuring their vertical and lateral dimensions with Scanning Electron Microscopy (SEM) before and after annealing. Gratings with line width from 10 nm up to 300 nm are used as examples. Shrinkage may vary for vertical dimensions, for horizontal dimensions, and for patterned vs. unpatterned films.

FIG. 7 shows SEM pictures of imprinted gratings with linewidth of 10 nm (SEM pictures 700, 710) and of 270 nm (SEM pictures 720, 730) for two different annealing conditions. The post annealing step can be used to fabricate 5 nm titania nanostructures as shown in SEM picture 710. The shrinkage for lateral dimensions in some instances may be independent of the initial sizes of the gratings. For example, 10 nm wide lines shrink with the same proportion that a 270 nm wide lines shrink for a same annealing condition. On the contrary, the lateral and the vertical shrinkage of a same pattern is different. For example, in one embodiment shrinkage in the lateral and vertical dimensions at 400° C. may be around 50% and 62%, respectively, as shown in SEM pictures 720-730. In one embodiment, the dispersion used to create the film having the hybrid organic-inorganic phase may be tuned such that lateral shrinkage is approximately 0% and/or the vertical shrinkage is about 40%.

An additional property of TiO₂ imprinted films is their high etching resistance for pattern transfer into other active layers for building multi-level functional films. Imprinted TiO₂ gratings may be transferred into silicon by plasma etching (e.g., by reactive ion etching). In one embodiment, the residual layer of the NIL resist film is etched first with a gas mixture of 18 sccm CF₄ and 2 standard cubic centimeters per minute (sccm) O₂, at 10 milliTorr (mT) and room temperature for 15 seconds. Other etch process parameters may also be used. Pattern transfer into silicon may then be performed by cryogenic temperatures with SF₆ and O₂ gases, and allows reaching an etching selectivity higher than 20 for samples annealed at 400° C.

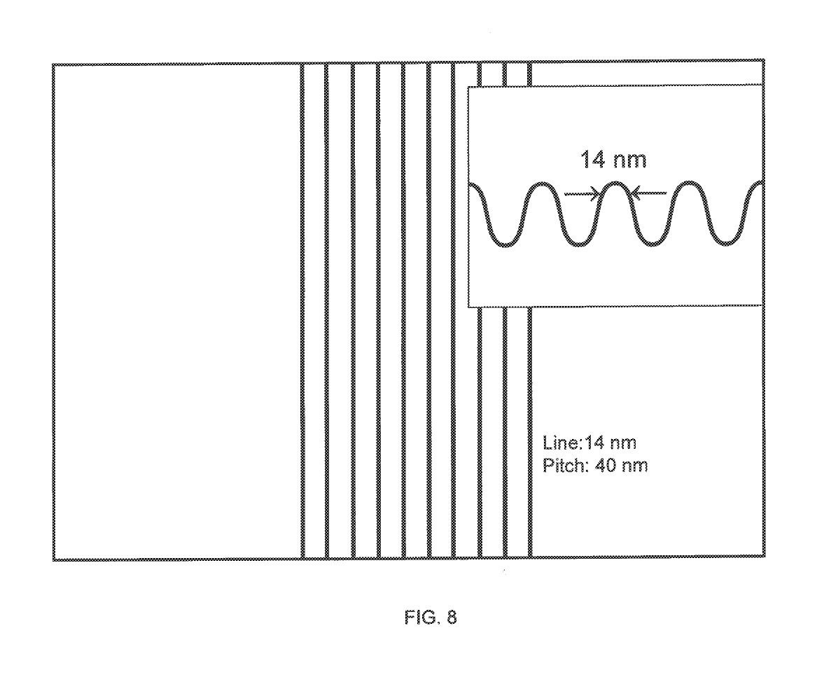

FIG. 8 illustrates SEM micrographs of 40 nm pitch patterns, having 14 nm line width, transferred into silicon by using RIE and the TiO₂-based resin as an etching mask. The TiO₂-based resin may be formed from a combination of a metal oxide precursor, an organic acid, an organic polymer, a photoinitiator, and a solvent, as discussed with reference to FIGS. 1-4. In one embodiment, imprinted gratings are annealed before etching. For example, the imprinted gratings may be annealed at 500° C. for 10 min before etching in one embodiment. FIG. 8 shows that the process allows the transfer of sub-15 nm feature sizes with good quality and demonstrates that titania can be used as an etching mask to transfer sub-20 nm patterns.

The proposed approach described in embodiments promises to drastically simplify the fabrication of photonic devices and the future development of novel nanophotonic structures, which are very difficult to achieve by conventional nanofabrication processes. One example of a printable photonic structure fabricated using techniques set forth herein is a simple photonic device based on TiO₂ gratings. A chip may be composed of insertion gratings (having a period of 612 nm in one example) separated by steps (1 mm steps in one example) of the output gratings (having a period of 343 nm in one example) over a length (e.g., a 10 mm length). Titania structures may be directly imprinted onto a Si/SiO₂/Si₃N₄ planar optical waveguide substrate. In one embodiment, the substrate has an 8 μm-thick SiO₂ layer and 150 nm-thick Si₃N₄ layer used as lower cladding and waveguide core, respectively. TE-polarized laser light with the wavelength of 532 and 635 nm may be coupled into the planar waveguide at the input grating such that it passes through the set of output gratings. Corresponding output signals may then be monitored.

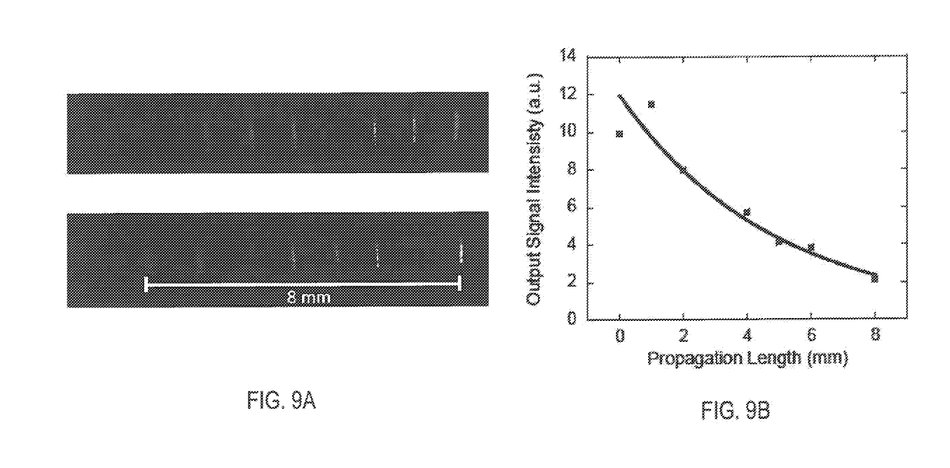

FIGS. 9A-9B illustrate optical characterization of an example imprinted photonic chip, in accordance with one embodiment. FIG. 9A shows a CCD image of the optical signals from output gratings. Decay from right to the left is mainly due to the gray losses in the waveguide. FIG. 9B shows plotted output signal intensity vs. propagation length and the corresponding exponential decay fit. The plotted output signal is of titania gratings annealed at 450° C. for 1 h to produce the example imprinted photonic chip.

FIG. 9A shows corresponding output signals, thus indicating that the imprinted TiO₂ gratings were successfully used for coupling incident laser light into the waveguide core and back. The intensity of the output light allows estimating the gray losses in the Si₃N₄ films. Under assumption of weak coupling, decay of the output signals vs. propagation distance is due to the gray losses in the waveguide. Measured intensities may be fitted by the exponential decay function for calculation of the gray loss coefficient, as shown in FIG. 9B. In one embodiment, the propagation losses are found to be around 8 dB/cm and 3-4 dB/cm at an input wavelength of 532 nm and 635 nm, respectively. The propagation losses shown in this example are low enough to allow fabrication of TiO₂-based photonic circuits on Si/SiO₂/Si₃N₄ planar waveguides. Such photonic circuits may be used for devices that operate with light in the visible to infrared wavelength range.

In one embodiment, a full planar lightwave circuit (PLC) is formed. One example PLC circuit is imprinted into a TiO₂-based film deposited over a Si, SiO₂ and/or Si₃N₄ substrate. For example, the substrate may include a 150-nm thick Si₃N₄ film that acts as a waveguide core and an 8 μm thick SiO₂ layer used as lower cladding, deposited over a Si substrate. Some imprinted structures that may be included in the PLC include single mode ridge waveguides (RWG), wavelength demultiplexers based on digital planar holograms (DPH), and directional light couplers.

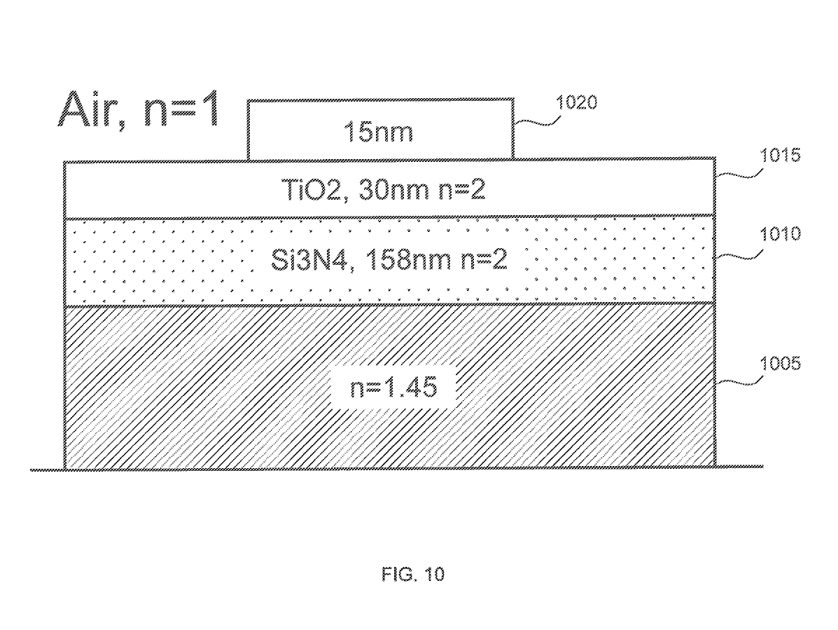

Ridge waveguides with compact size, low power consumption and high performance may drive the miniaturization of integrated PLC devices. Their fabrication into high refractive index materials is very beneficial because the miniaturization limit of waveguides is dominated by the diffraction limit λ/2n (λ: wavelength, n: refractive index of the core). TiO₂ with its high refractive index is an excellent candidate for high performance waveguides. In one embodiment, multi-mode ridge waveguides are imprinted onto titania based films, as shown in FIG. 10. The titania-based films manufactured in accordance with embodiments may have a refractive index of over 2.0. Additionally, optical propagation losses of the functional titania-based films of 40 dB/cm may be achieved for a waveguide formed of an example titania-based film with a refractive index of 1.8 at 632 nm wavelength. The titania-based film may be tuned to achieve optical propagation losses of 5 dB/cm to 50 dB/cm for amorphous and anatase forms of the film.

In one embodiment, a printed demultiplexer-on-chip based on a digital planar hologram (DPH) is manufactured using the techniques described with regards to FIGS. 1-4. The DPH devices may consist of computer-designed planar holograms and involve millions of lines specifically located and oriented to direct output light into focal channels according to the wavelength. The geometry of the gratings (linewidth and height) is determined in accordance with the variation of the effective refractive index inside the guiding layer and with the operating wavelength bandwidth. In one embodiment, optical demultiplexer chips (e.g., having from 4 to 100 channels in one embodiment) are formed. In one embodiment, the optical demultiplexer chips work at a central wavelength of 635 nm. In one embodiment, DPHs are used to fabricate a miniaturized spectrometer.

The holographic chips may be fabricated by lithography and plasma etching into a waveguide core material (e.g., SiO₂ and Si₃N₄), as shown in FIG. 10. FIG. 10 illustrates a cross sectional side view of a portion of a printed demultiplexer-on-chip based on a digital planar hologram (DPH). As shown, an imprinted nanostructure 120 has a feature size of 15 nm. The imprinted nanostructure 120 is composed of a titania-based film and is disposed over a titania-based film 1015. The titania based film 1015 is shown to have a thickness of 30 nm, but may also have other greater or lesser thicknesses. The thickness of the residual titania-based film 1015 underneath the hologram may be varied between 30 and 60 nm. In one embodiment, the thickness of the residual titania-based film 1015 is optimized to be the thinnest possible (e.g., <20 nm) after the post-annealing treatment. The titania-based film 1015 is deposited on the top of a Si/SiO2/Si3N4 waveguide substrate that includes an Si₃N₄ layer 1010 over an SiO₂ layer 1005.

Additional embodiments of the invention include a novel nanomanufacturing technique for fabricating self-cleaning, low cost and ultra-sensitive surface-enhanced Raman spectroscopy (SERS) substrates. Results of direct imprinting of functional films allow the patterning of a titania-based material (or other metal oxide based material) with high optical and photocatalytic properties. The printing may be performed with high resolution. This technology may be combined with noble metal deposition to create a new class of SERS substrates with unique self-cleaning and high sensitivity properties and may have applications in the biomedical area. An example reusable SERS substrate may have a high sensitivity and reproducibility. In some embodiments, fabrication of high resolution nanostructure substrates by bottom up block-copolymer self-assembly and top down nanoimprint lithography is performed.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the terms “about” and “approximate” are used herein, this is intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
mixing a metal oxide precursor with an organic acid to form a hybrid organic-inorganic phase;
mixing the hybrid organic-inorganic phase with a photoinitiator and a solvent to form a dispersion comprising the hybrid organic-inorganic phase;
forming a film on a substrate from the dispersion, the film comprising the hybrid organic-inorganic phase; and
annealing the film to transform the hybrid organic-inorganic phase into an inorganic phase.

2. The method of claim 1, wherein the metal oxide comprises at least one of a metal alkoxide or a metal halide.

3. The method of claim 1, wherein:
the organic acid is a functionalized acid comprising at least one of 3-butenoic acid, acetic acid, acrylic acid, methacrylic acid, or epoxy-functionalized acid; and
the metal oxide precursor reacts with the organic acid to form a functional ester.

4. The method of claim 1, wherein:
the organic acid is a non-functionalized acid comprising at least one of acetic acid, propanoic acid, or butenoic acid; and
the organic acid stabilizes the metal oxide precursor in a solution.

5. The method of claim 1, wherein the organic polymer is an olefinic polymer comprising at least one of methacrylate, acrylate, an epoxide, or a vinyl ether.

6. The method of claim 1, wherein annealing the film comprises thermally treating the film at a temperature of 150° C. to 800° C. for a duration of 1 minute to 9 hours.

7. The method of claim 1, wherein annealing the film comprises exposing the film to UV radiation at a power of 10-200 W/cm² for a duration of 1 minute to 9 hours.

8. The method of claim 1, wherein the solvent comprises at least one of a hexane, toluene, dimethyl formamide, or propylene glycol methyl ether acetate (PGMEA).

9. The method of claim 1, further comprising:
patterning the film by performing a direct imprinting process comprising:
depositing the dispersion onto the substrate to form the film, wherein the depositing is performed using at least one of a spin coating, dip coating, drop casting, spray coating, or doctor blade technique; and
pressing a mold into the film at a pressure of at least 10 pounds per square inch (psi).

10. The method of claim 9, wherein forming the film comprises:
depositing the dispersion onto the substrate to form a first layer of the film;
thermally treating the first layer at a temperature of up to 200° C. to remove the solvent from the first layer;
depositing the dispersion onto the first layer to form a second layer of the film; and
thermally treating the second layer at a temperature of up to 150° C. to remove the solvent from the second layer.

11. The method of claim 1, further comprising:
patterning the film by performing a reverse imprinting process, comprising:
depositing the dispersion onto a mold to form the film;
depositing an adhesive onto at least one of the film or the substrate; and
pressing the mold onto the substrate to transfer the film from the mold to the substrate, wherein the transferred film is patterned based on a pattern of the mold.

12. The method of claim 11, wherein forming the film comprises:
depositing the dispersion onto the mold to form a first layer of the film;
thermally treating the first layer to remove the solvent from the first layer;
depositing the dispersion onto the mold to form a second layer of the film; and
thermally treating the second layer to remove the solvent from the second layer.

13. The method of claim 11, wherein the annealing is performed at less than 600° C.

14. The method of claim 1, further comprising:
patterning the film by performing a non-direct imprinting process comprising:
forming a layer of patternable resist over the film after performing the annealing;
performing lithography to pattern the film; and
etching the patterned film.

15. The method of claim 1, wherein the film comprises a component of a nanophotonic structure, the nanophotonic structure comprising at least one of a ridge waveguide, a microlens array, a 1-dimensional photonic crystal or a planar hologram.

16. An imprinted nanophotonic device comprising:
a substrate; and
a printed film disposed on the substrate, the printed film comprising a metal oxide and having a refractive index of 1.7-2.2, wherein the printed film is free from cracks and has at least one feature with a feature size of less than 1000 nm.

17. The imprinted nanophotonic device of claim 16, wherein the printed feature has at least one feature with a feature size of 5-10 nm.

18. The imprinted nanophotonic device of claim 16, wherein the printed film has a thickness of 0.5-1.5 microns.

19. The imprinted nanophotonic device of claim 16, wherein the imprinted nanophotonic device comprises at least one of a ridge waveguide, a microlens array, a 1-dimensional, 2-dimensional or 3-dimensional photonic crystal, a planar hologram, or a surface-enhanced Raman spectroscopy (SERS) device.

20. A nanophotonic device manufactured by a process comprising:
providing a metal oxide precursor;
mixing the metal oxide precursor with an organic acid, an organic polymer and a photoinitiator in a solvent to form a dispersion comprising a hybrid organic-inorganic phase;
forming a film on a substrate from the solution, the film comprising the hybrid organic-inorganic phase; and
annealing the film to transform the hybrid organic-inorganic phase into an inorganic phase.
